(19) United States
(12) Patent Application Publication
(10) Pub. No.: US 2018/0345913 A1
(43) Pub. Date: Dec. 6, 2018

(54) GEARED MOTOR FOR AUTOMOBILE WIPER SYSTEM

(71) Applicant: Valeo Systèmes d'Essuyage, Le Mesnil Saint Denis (FR)

(72) Inventor: Jose-Luis Herrada, Le Mesnil Saint Denis (FR)

(73) Assignee: Valeo Systèmes d'Essuyage, Le Mesnil Saint Denis (FR)

(21) Appl. No.: 15/993,027

(22) Filed: May 30, 2018

(30) Foreign Application Priority Data
Jun. 2, 2017 (FR) 1754892

(51) Int. Cl. B60S 1/26; H02K 7/08; B60S 1/08

(52) U.S. Cl. CPC B60S 1/26; H02K 7/081; F16H 2057/0213; F16C 2326/09; B60S 1/08

(57) ABSTRACT

The invention relates to a gear motor for a motor vehicle wiper system, comprising a direct current electric motor, which in particular is brushless, the electric motor (2) comprising a stator (4) and a rotor (5), the stator (4) comprising a plurality of coils (6) for electromagnetic excitation of the rotor (5), and the rotor (5) comprising a magnet which is fitted in order to be driven with a movement of rotation around an axis of rotation, the gear motor (1) also comprising a rotation shaft (8), known as the motor shaft, which is configured to be rotated by the rotor (4), the gear motor (1) comprising a bearing (20) for guiding in rotation of the motor shaft (8), and a brace (25) for axial blocking of the bearing (20) added onto the motor shaft, the brace (25) being secured on the motor shaft (8).

The invention relates to a gear motor for a motor vehicle wiper system.

Gear motors are substantially composed of an electric motor coupled to a reducer mechanism which is responsible for de-multiplying the speed of the motor in order to obtain substantial transmission torque in rotation.

Different types of electric motors can be used in a gear motor, and in particular brushless direct current electric motors, which have many advantages, such as a long service life, a reduced size and consumption, as well as a low noise level.

The control of the electric motors is more complex than electric motors with brushes, since, in order to permit satisfactory operation, it is necessary to know precisely the angular position of the rotor of the brushless direct current electric motor.

Electric motors of this type comprises electromagnetic excitation coils arranged at the stator and supplied alternately via an inverter in order to permit driving of the rotor.

The rotor is fitted in order to be driven with a movement of rotation around an axis of rotation, and rotates a shaft, known as the motor shaft, of the gear motor.

In order to optimise the operation of the gear motor, it is known to provide at least one bearing to guide the movement of rotation of the motor shaft.

A bearing of this type comprises an inner ring and an outer ring separated by a cage provided with rolling elements, the movements of the inner ring being decoupled from those of the outer ring.

It is preferable to block the bearing so that it can withstand axial forces which are exerted during the rotation of the motor shaft.

A solution envisaged consists of welding the inner ring on the motor shaft.

However, this solution has numerous disadvantages since a bearing is not only often made of steel, and consequently difficult to weld, but in addition the increase in heat necessary for the welding marks the rolling elements on the rings.

Marking of this type leads irremediably to defective operation of the bearing, and consequently to defective operation of the gear motor.

The objective of the invention is to improve the situation.

For this purpose, the invention relates to a gear motor for a motor vehicle wiper system, comprising a direct current electric motor, which in particular is brushless, the motor comprising a stator and a rotor, the stator comprising a plurality of coils for electromagnetic excitation of the rotor, and the rotor comprising a magnet which is fitted in order to be driven with a movement of rotation around an axis of rotation, the gear motor also comprising a rotation shaft, known as the motor shaft, which is configured to be rotated by the rotor, the gear motor comprising a bearing for guiding in rotation of the motor shaft, and a brace for axial blocking of the bearing added onto the motor shaft, the brace being secured on the motor shaft.

Thus, thanks to the gear motor according to the present invention, the bearing is blocked by means of the brace, which itself is secured on the motor shaft.

In order to secure the brace on the motor shaft, it is then possible to provide a deformation, which for example is mechanical or thermal, of the motor shaft and/or of the brace, the bearing for its part remaining intact.

According to another characteristic of the invention, the brace is a ring.

According to another characteristic of the invention, the brace is crimped or welded or glued or riveted or fitted by clamped adjustment on the motor shaft.

According to another characteristic of the invention, the motor shaft comprises a groove for receipt of the ring forming the brace, the ring being compressed resiliently and retained in position in the groove.

According to another characteristic of the invention, the bearing comprises an inner ring and an outer ring, the brace being arranged against the inner ring of the bearing.

According to another characteristic of the invention, the gear motor comprises a resilient ring for retention of the bearing arranged against the inner ring of the bearing, on a side opposite the brace.

According to another characteristic of the invention, the gear motor comprises a second brace arranged against the inner ring of the bearing, on the side opposite the first brace, the second brace being secured on the motor shaft.

According to another characteristic of the invention, the bearing is arranged in the vicinity of an end of the motor shaft.

The invention also relates to a method for production of a gear motor for a motor vehicle wiper system, comprising a direct current electric motor, which in particular is brushless, the motor comprising a stator and rotor, the stator comprising a plurality of coils for electromagnetic excitation of the rotor, and the rotor comprising a magnet fitted in order to be driven with a movement of rotation around an axis of rotation, the gear motor also comprising a rotation shaft, known as the motor shaft, which is configured to be rotated by the rotor, the gear motor comprising a bearing for guiding in rotation of the motor shaft, and a brace for axial blocking of the bearing added onto the motor shaft, the method comprising a step of mechanical or thermal deformation of the motor shaft and/or of the brace, such as to secure the brace on the motor shaft.

The invention also relates to a motor vehicle wiper system, comprising a gear motor as previously described.

Other characteristics and advantages of the invention will become apparent from reading the following description, which is purely illustrative, and must be read in relation with the appended drawings in which:

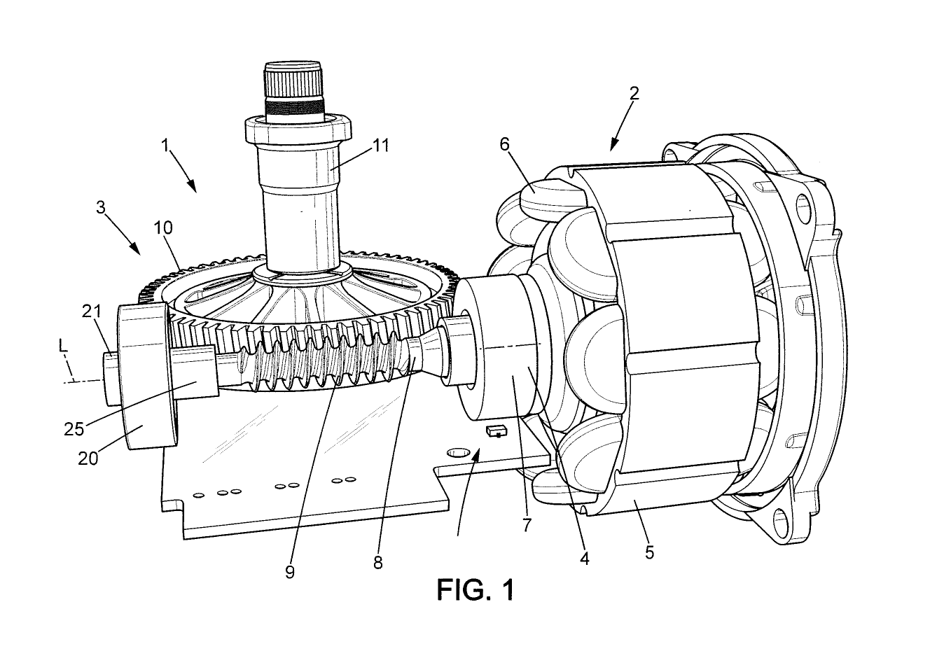

FIG. 1 illustrates a view in perspective of an electric gear motor according to the present invention; and

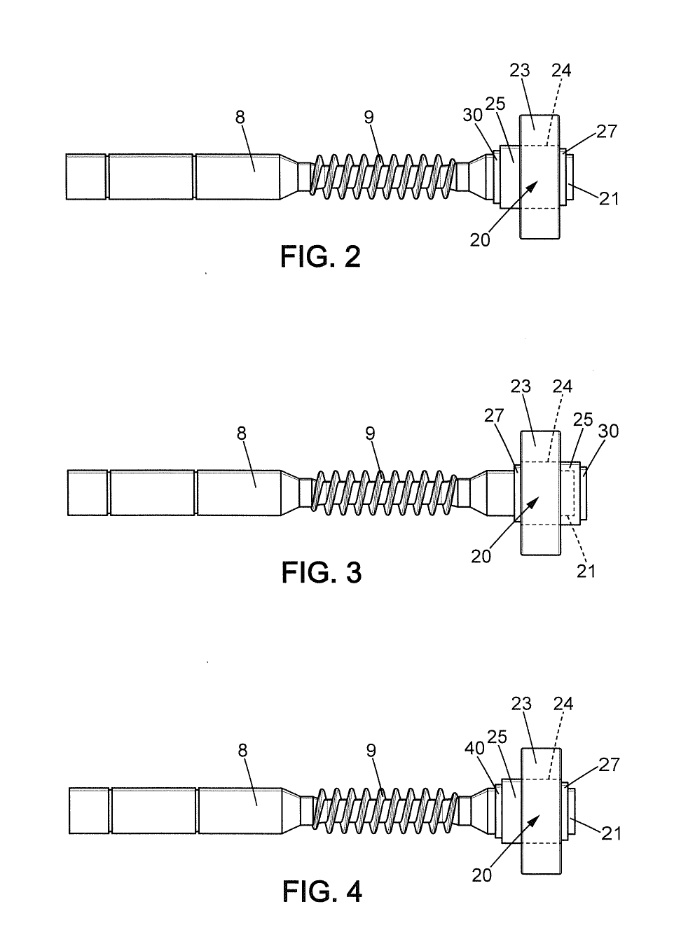

FIGS. 2 to 9 illustrate a motor shaft provided with a brace according to eight variant embodiments.

### GEAR MOTOR

The invention relates to a gear motor for a motor vehicle wiper system, with the reference 1.

The gear motor comprises a direct current electric motor 2, which is preferably brushless, and a reducer mechanism 3.

As shown in FIG. 1, the electric motor 2 comprises a rotor 4 and a stator 5.

The stator 5 comprises a plurality of electromagnetic excitation coils 6 of the rotor 4.

The rotor 4 comprises a multipolar magnet 7 fitted to be driven with movement of rotation around an axis of rotation with the reference L.

The electric motor 2 is configured such that the rotor 4 turns in the stator 5, which gives rise to rotation of a shaft 8 of the mechanism 3, known as the motor shaft 8, which is integral with the rotor 4.

The motor shaft 8 extends according to the axis of rotation L.

The motor shaft 8 comprises a threaded part 9 fitted in order to be engaged by a toothed wheel 10 of the reducer mechanism 3.

The toothed wheel 10 rotates an output shaft 11.

Thus, the speed of rotation at the output from the gear motor (i.e. the speed of rotation of the output shaft 11) is lower than the speed of rotation of the motor shaft 8.

The output shaft 11 is substantially perpendicular to the motor shaft 8.

As is apparent from the figures, a bearing 20 ensures the guiding of the motor shaft at one of the ends 21, 22 of the motor shaft 8, on the side opposite the electric motor 2.

As is known by persons skilled in the art, the bearing comprises an inner ring 24 and an outer ring 23 separated by a cage provided with rolling elements, the inner and outer rings being decoupled from one another.

In the figures, the inner ring 24 is illustrated in broken lines.

As shown in FIGS. 1 to 9, the gear motor 1 comprises a brace 25 for axial blocking of the bearing 20.

The brace 25 is added onto the motor shaft 8.

As shown in the figures, the brace 25 is a ring fitted onto the motor shaft 8.

The brace 25 is secured on the motor shaft 8, as will be described in detail.

Advantageously, the brace 25 has been subjected to mechanical or thermal deformation in order to be secured on the motor shaft.

This is the case according to a first embodiment illustrated in FIGS. 2 and 3, where the brace has been subjected to mechanical deformation during a crimping operation. The brace 25 is crimped on the motor shaft 8 (cf. reference 30).

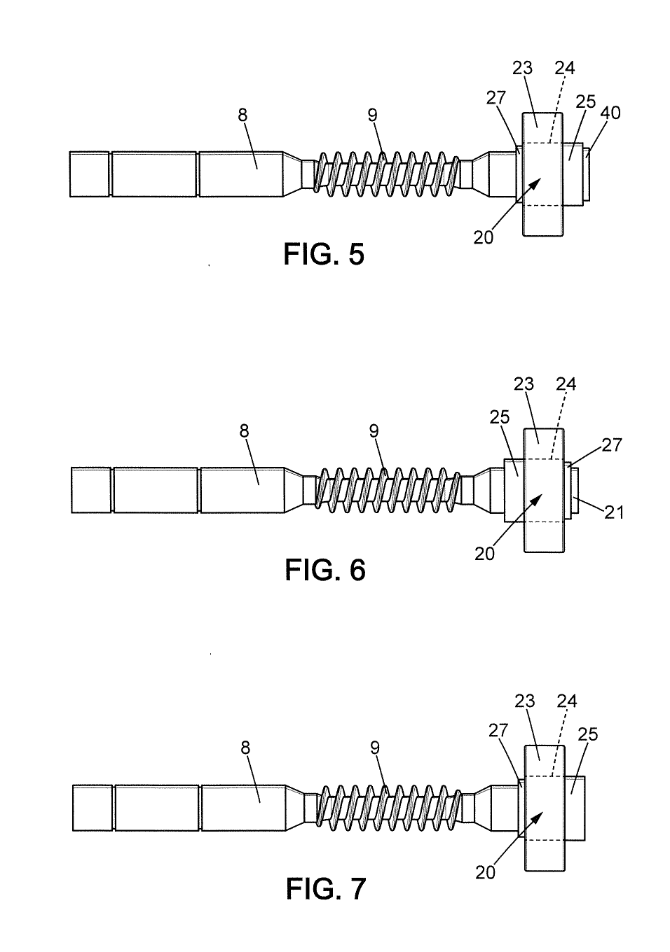

This is the case according to a second embodiment illustrated in FIGS. 4 and 5, where the brace has been subjected to a thermal deformation during a welding operation. In this case, the brace 25 is welded on the motor shaft 8 (cf. reference 40).

This is the case according to a third embodiment illustrated in FIGS. 6 and 7, where the brace has been subjected to a mechanical deformation during an operation by clamped adjustment, for example by fitting on a press.

It is also the case according to a fourth embodiment, illustrated in FIG. 9, where the brace is compressed resiliently and retained in position in a groove 26 in the motor shaft 8.

According to this embodiment, the brace is configured such that, despite a maximum axial force exerted on the brace 25 in the direction of drawing of the brace (arrow F) or in the direction of compression of the brace (arrow F′), the brace continues to be retained in the groove 26.

It is also the case according to other embodiments, not illustrated, according to which the brace is respectively riveted on the motor shaft or has tapping.

According to an embodiment not illustrated, the brace is glued on the motor shaft.

It can be noted that, for all the embodiments, the bearing is not subjected to any deformation.

According to all the embodiments, it is the brace 25 which absorbs the axial forces exerted on the bearing 20, because it is secured integrally on the motor shaft 8.

The bearing 20 is integral in movement with the motor shaft 8 by means of the brace 25.

As can be seen in FIGS. 3 to 9, the brace 25 is arranged against the inner ring 24 of the bearing 20.

Advantageously, a resilient ring 27 is arranged against the inner ring 24 of the bearing 20, on the side opposite the brace 25.

Preferably, the resilient ring 27 has an opening. It can be a circlip (registered trademark)

The resilient ring 27 is positioned in a groove in the motor shaft 8.

The resilient ring 27 makes it possible to retain the bearing 20 axially.

The resilient ring 27 is illustrated in FIGS. 2 to 7 and 9.

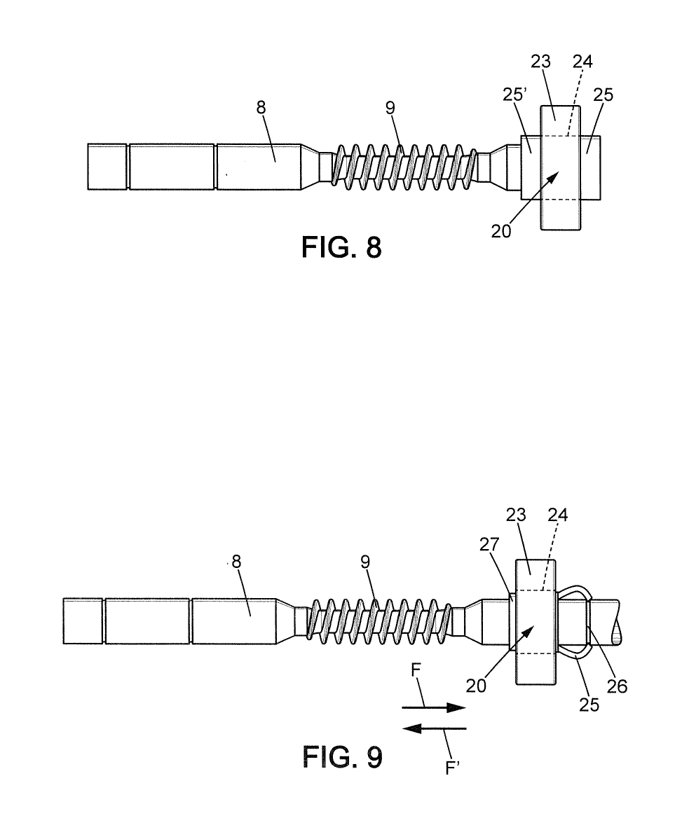

In the variant in FIG. 8, the gear motor 1 comprises a second brace 25′ arranged against the inner ring of the bearing, on the side opposite the first brace, the second brace being secured on the motor shaft as previously described for the first brace.

The invention also relates to a method for production of the gear motor 1.

The method comprises a step of mechanical or thermal deformation of the motor shaft and/or of the brace, such as to secure the brace on the motor shaft, as already described.

It will be appreciated that the other end of the motor shaft 8 can also be provided with a bearing and with one or two braces 25.

1. A gear motor for a motor vehicle wiper system, comprising:
a direct current electric motor, which is brushless, the electric motor comprising a stator and a rotor,
the stator comprising a plurality of coils for electromagnetic excitation of the rotor,
the rotor comprising a magnet which is fitted to be driven with a movement of rotation around an axis of rotation;
a rotation shaft, known as the motor shaft, which is configured to be rotated by the rotor; and
a bearing for guiding in rotation of the motor shaft, and a brace for axial blocking of the bearing added onto the motor shaft, the brace being secured on the motor shaft.

2. The gear motor according to claim 1, wherein the brace is a ring.

3. The gear motor according to claim 1, wherein the brace is one selected from the group consisting of: crimped, welded, glued, riveted, and fitted by clamped adjustment on the motor shaft.

4. The gear motor according to claim 1, wherein the motor shaft comprises a groove for receipt of the ring forming the brace, the ring being compressed resiliently and retained in position in the groove.

5. The gear motor according to claim 1, wherein the bearing comprises an inner ring and an outer ring, the brace being arranged against the inner ring of the bearing.

6. The gear motor according to claim 5, further comprising a resilient ring for retention of the bearing arranged against the inner ring of the bearing, on a side opposite the brace.

7. The gear motor according to claim 5, further comprising a second brace arranged against the inner ring of the bearing, on the side opposite the first brace, the second brace being secured on the motor shaft.

8. The gear motor according to claim 1, wherein the bearing is arranged in the vicinity of an end of the motor shaft.

9. The gear motor according to claim 8, further comprising a second bearing in the vicinity of another end of the motor shaft.

10. A method for production of a gear motor for a motor vehicle wiper system, comprising a direct current electric motor, which is brushless, the motor comprising a stator and a rotor, the stator comprising a plurality of coils for electromagnetic excitation of the rotor, and the rotor comprising a magnet fitted to be driven with a movement of rotation around an axis of rotation, the gear motor also comprising a rotation shaft, known as the motor shaft, which is configured to be rotated by the rotor, the gear motor comprising a bearing for guiding in rotation of the motor shaft and a brace for axial blocking of the bearing added onto the motor shaft, the method comprising:
mechanical or thermal deformation of the motor shaft and/or of the brace, to secure the brace on the motor shaft.

11. A motor vehicle wiper system, comprising a gear motor according to claim 1.
